(19) United States
(12) Patent Application Publication
(10) Pub. No.: US 2023/0166607 A1
(43) Pub. Date: Jun. 1, 2023

(54) ELECTRIC FOUR-WHEEL DRIVE SYSTEM AND METHOD FOR CONTROLLING A MOTOR VEHICLE

(71) Applicants: HYUNDAI MOTOR COMPANY, Seoul (KR); KIA CORPORATION, Seoul (KR)

(72) Inventors: Giulia Ludovici, Gross Gerau (DE); Marco Favilli, Frankfurt am Main (DE)

(73) Assignees: HYUNDAI MOTOR COMPANY, Seoul (KR); KIA CORPORATION, Seoul (KR)

(21) Appl. No.: 17/991,377

(22) Filed: Nov. 21, 2022

(30) Foreign Application Priority Data
Nov. 30, 2021 (DE) 102021213549.8

(51) Int. Cl. B60L 15/20; B60K 7/00

(52) U.S. Cl. CPC B60L 15/2036; B60K 7/0007; B60L 2240/14; B60L 2240/22; B60L 2240/24; B60L 2240/423

(57) ABSTRACT

An electric four-wheel drive (E-4WD) system and control method for a motor vehicle includes four wheel motors. Each wheel motor is an electric motor configured to drive one respective wheel corresponding to the wheel motor. Each wheel motor includes a stator implemented on a suspension structure of the respective wheel and a rotor implemented on a semi-axle connected to the respective wheel to rotate together with the respective wheel relative to the stator. The wheel motors are configured to drive the wheels independently of each other.

### CROSS-REFERENCE TO RELATED APPLICATION

This application claims the benefit of and priority to German Patent Application No. 102021213549.8, filed with the German Patent and Trade Mark Office on Nov. 30, 2021. The entire contents of this prior filed application are incorporated herein by reference.

### TECHNICAL FIELD

The present disclosure pertains to an electric four-wheel drive system for a motor vehicle, a motor vehicle with such an electric four-wheel drive system, and a method for controlling a motor vehicle with such an electric four-wheel drive system.

### BACKGROUND

A four-wheel drive (4WD), also called 4×4, refers to a two-axled vehicle drivetrain capable of providing torque to all of its wheels simultaneously. The 4WD feature may be full-time or on-demand and is typically linked via a transfer case providing an additional output drive shaft and, in many instances, additional gear ranges.

High performance 4WD vehicles typically have higher weight, which may limit maximum speed and a weight-to-power ratio and may furthermore result in substantial packaging constraints especially in compact vehicles. Among others, both extreme cornering and fast driving may be limited due to the resulting higher inertia. This may lead to underperformance in track-driving scenarios, for example.

Document US 8,714,288 describes a hybrid variant automobile drive system for improving fuel efficiency while retaining an acceleration profile of the automobile. The system includes a supplemental motor, which can aid the main engine in driving the wheels. The supplemental motor uses an alternative energy source, aside from the fuel used by the engine to drive the wheels. For example, the alternative energy source may be a capacitor charged by an energy generation unit generating energy on basis of, for example, solar panels, a ram induction generator, a regenerative braking unit, and/or a heat exchange unit.

### SUMMARY

In light of the above, there is a need to find lightweight solutions that improve driving control and performance of four-wheel drive (4WD) vehicles.

To this end, the present disclosure provides an electric 4WD system, a motor vehicle, and a method for controlling a motor vehicle.

According to one aspect of the disclosure, an electric four-wheel drive (E-4WD) system for a motor vehicle includes wheel motors. Each wheel motor is configured as an electric motor to drive one respective wheel associated therewith. Each wheel motor includes a stator implemented on a suspension structure of the respective wheel and a rotor implemented on a semi-axle connected to the respective wheel to rotate together with the respective wheel relative to the stator. The wheel motors are configured to drive the respective wheels independently of each other.

According to another aspect of the disclosure, a motor vehicle comprises an E-4WD system according to the disclosure.

According to yet another aspect of the disclosure, a method is provided for controlling wheels of a motor vehicle with four wheel motors. Each wheel motor is configured as an electric motor driving one respective wheel associated therewith. Each wheel motor includes a stator implemented on a suspension structure of the respective wheel and a rotor implemented on a semi-axle connected to the respective wheel to rotate together with the respective wheel relative to the stator. The wheel motors drive the associated wheels independently of each other.

One concept of the present disclosure is to implement a dedicated electric motor for each wheel directly on the corresponding semi-axle. This may aid a main engine of the vehicle at least under certain conditions in driving the wheels so that each wheel may be driven independently of the other wheels leading to improved vehicle driving control. More specifically, the rotors of the electric motors are integrated with the semi-axles such that each rotor and the respective semi-axle, and hence the corresponding wheel, rotate at the same speed. The stators on the other hand are integrated with the respective wheel suspension structure.

Positioning the electric motors on the semi-axles has the advantage that sufficient space is available for the installation of the electric motor assembly. A special or modified gearbox is not required in this configuration, as the electric motors may be mounted directly on the semi-axles. Consequently, weight and performance reduction of the overall electric drive line can be significantly lowered compared to conventional solutions. The electric motors may be used selectively and/or on demand, i.e., only for short time intervals, when additional torque for some or all of the wheels is specifically requested or needed. In particular, the electric wheel motors of the present disclosure may only be activated in addition to a main energy source, e.g. an internal combustion engine, a hybrid drive train, and so on, and only under certain circumstances where additional torque may be beneficial for some or all wheels. This also implies that a size of the electric wheel motors may be kept rather small in terms of power supply with a consequent reduction in weight of the overall system.

It should be understood that the terms “vehicle” or “vehicular” or other similar term as used herein are inclusive of motor vehicles in general. Such motor vehicles may encompass passenger automobiles including sports utility vehicles (SUV), buses, trucks, various commercial vehicles, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, such as for example, a vehicle that is both gasoline-powered and electric-powered.

Advantageous embodiments and improvements of the present disclosure are found throughout the present disclosure. When a part, unit, component, module, controller (i.e., motor control), or the like of the present disclosure is described as having a purpose or performing an operation, function, or the like, the part, unit, component, module, controller, or the like should be considered herein as being “configured to” meet that purpose or to perform that operation or function. Further, as is well known, the motor control described herein, as well as other electronic components, may include at least one processor, a storage edium, and/or a memory to carry out the processes or functions of the motor control. The memory and storage medium may include various types of trannsitory, non-transitory, volatile, or non-volatile storage media, such as a ROM (Read Only Memory) and a RAM (Random Access Memory). The processes of the motor control may be implemented directly by hardware executed by the processor, software, or a combination thereof. The software may reside in the storage medium.

According to an embodiment of the disclosure, the wheel motors may be powered by at least one supercapacitor.

A supercapacitor is a high-capacity capacitor with a capacitance value much higher than common capacitors, but with lower voltage limits, that bridges the gap between electrolytic capacitors and rechargeable batteries. It typically stores 10 to 100 times more energy per unit volume or mass than electrolytic capacitors, can accept and deliver energy much faster than batteries, and tolerates many more charge and discharge cycles than rechargeable batteries. Supercapacitors are used in applications requiring many rapid charge/discharge cycles with high power output, rather than long-term compact energy storage, where they are used for regenerative braking, short-term energy storage, or burst-mode power delivery. Hence, supercapacitors are ideally suited for the present purpose where they can provide high density power on demand on very short time scales.

According to an embodiment of the disclosure, the at least one supercapacitor may be configured to be recharged by regenerative braking.

The supercapacitors may thus be recharged frequently while driving so that delivery of additional torque is possible in an almost continuous fashion. Due to their very high loading speed, the supercapacitors may be reloaded sufficiently on short time scales allowing frequent usage of the electric wheel motors to provide additional torque in a dynamic vein, e.g. during track driving.

According to an embodiment of the disclosure, the wheel motors may be configured as radial flux permanent magnet motors, wherein one or several rotor magnets of each respective rotor may be mounted on and/or may be integrated in the respective semi-axle.

The four permanent magnet rotors are not installed on the wheels but instead are directly assembled and bound on the semi-axles, i.e., before the suspension, such that the magnetic flux flows radially outwards from the longitudinal extension of the semi-axles. The concept or motivation behind this is to simplify the structure, thereby avoiding any impact on or modification of the gearbox and eventually a limited slip differential, thus furthermore reducing the weight of the vehicle.

According to an embodiment of the disclosure, the rotor magnets of each rotor may be configured as circumferential shell elements arranged around an axial direction of the respective semi-axle.

For example, the rotor magnet may include a number of identically configured shell elements, which are equally spaced around the semi-axle and may be assembled directly on and bound to the semi-axle. In that vein, the shell elements may be provided on a surface of the semi-axle. However, alternatively or additionally, magnet elements may also be integrated in the semi-axle, e.g., as internal magnets.

According to an embodiment of the disclosure, the system may further include a motor control configured to activate and control the wheel motors selectively to provide dynamic torque management, such as active torque vectoring, of the wheels on demand during a driving situation.

Hence, the present disclosure provides a control strategy for enabling an orchestrated dynamic management of the torque on all wheels. To this end, the motor control may communicate with or may be integrated in an engine control unit of the vehicle so that provision of torque from an internal combustion engine (ICE) may be tuned in concert with the wheel motors. In that vein, dynamic traction control may be introduced on top an engine driven motion, in particular to generate an active electric torque vectoring that is able to correct the path of the car according to the vehicle motion by coordinating the torque actuation on each wheel. On this basis, the system may, for example, compensate understeering and/or oversteering and basically any driving situation in between.

According to an embodiment of the disclosure, the motor control may be configured to provide the dynamic torque management depending on a driver steering angle request, a current yaw angle, and/or a current vehicle speed.

Hence, the vehicle stability may be improved by the motor control by splitting up the torque among the four wheels on the basis of the four independent electric motors depending on a steering angle request, a yaw angle, and/or vehicle speed. In one particular example, torque vectoring may be initiated only when some or all of the beforementioned parameters surpass a predefined threshold.

According to an embodiment of the disclosure, the motor control may be configured to provide additional electric torque to the wheels during acceleration phases depending on a driver acceleration request.

This may be utilized, for example, to provide a “sport mode” or other dynamic driving modes where additional torque is provided on top of, e.g., an ICE during acceleration phases.

According to an embodiment of the disclosure, the motor control may be configured to provide the additional electric torque if/when the driver acceleration request surpasses an acceleration threshold and if/when a state of charge of a respective supercapacitor powering the wheel motors surpasses a charge threshold.

Hence, not only the amount of additional torque may depend on driver request (i.e. accelerator pedal position) and supercapacitor state of charge level, but these parameters may also determine whether additional torque is provided at all in a certain driving situation. Below the state of charge and acceleration request thresholds only an ICE drive may be enabled.

According to an embodiment of the disclosure, the motor control may be configured to drive the wheels solely on the basis of the wheel motors if/when a current vehicle speed is below a speed threshold and if/when a state of charge of a respective supercapacitor powering the wheel motors surpasses a charge threshold.

Hence, additionally or alternatively to the abovementioned sport mode, a low-speed creeping mode or other driver assistance mode (powered by supercapacitors) may also then be available, e.g. for convenience features like automated valet parking. In a similar vein as the sport mode, the low-speed mode also may only be activated when the supercapacitors are fully or at least sufficiently charged with values higher than a predefined threshold level. This mode may be set for electric start and creeping, for example, during low loads and low-speed driving. The two mentioned modalities, i.e., sport mode and creep mode, may be chosen and/or set by a driver of the vehicle.

The technical concepts of the present disclosure are explained in greater detail with reference to embodiments depicted in the drawings as appended.

### BRIEF DESCRIPTION OF THE DRAWINGS

The accompanying drawings are included to provide a further understanding of the present disclosure and are incorporated in and constitute a part of this specification. The drawings illustrate the embodiments of the present disclosure and together with the description serve to explain the principles of the disclosure. Other embodiments of the present disclosure and many of the intended advantages of the present disclosure should be readily appreciated as they become better understood by reference to the following detailed description. The elements of the drawings are not necessarily to scale relative to each other. In the figures, like reference numerals denote like or functionally like components, unless indicated otherwise.

FIG. 1 schematically shows a cross sectional view of an electric four-wheel drive (E-4WD) system according to an embodiment of the disclosure.

FIG. 2 is a detailed perspective view of the E-4WD system from FIG. 1.

FIG. 3 schematically depicts a motor vehicle equipped with the system from FIG. 1.

FIG. 4 schematically shows a method for controlling the wheels of the motor vehicle of FIG. 3 with the system of FIG. 1.

FIGS. 5 and 6 show two driving situations with the vehicle of FIG. 3.

Although specific embodiments are illustrated and described herein, it should be appreciated by those of ordinary skill in the art that a variety of alternate and/or equivalent implementations may be substituted for the specific embodiments shown and described herein without departing from the scope of the present disclosure. Generally, this application is intended to cover any adaptations or variations of the specific embodiments discussed herein.

### DETAILED DESCRIPTION OF THE EMBODIMENTS

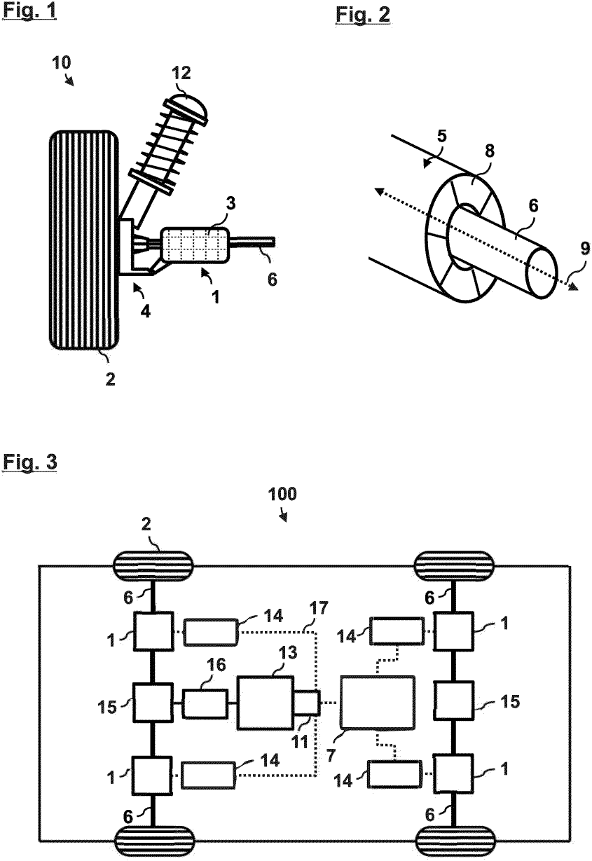

FIG. 1 schematically shows a cross sectional view of an electric four-wheel drive (E-4WD) system 10 according to an embodiment of the disclosure. A motor vehicle 100 equipped with the E-4WD system 10 is shown in FIG. 3.

As can be understood with reference to FIG. 3, the E-4WD system 10 is provided in addition to a main vehicle engine 13, e.g. a internal combustion engine (ICE), to provide direct and independent actuation of each wheel 2 for dynamic and on-demand traction control of the motor vehicle 100, e.g. under dynamic and/or demanding driving situations.

To this end, the E-4WD system 10 comprises four wheel motors 1, one for each wheel 2 of the vehicle 100. Each wheel motor 1 is configured to drive one respectively associated wheel 2, i.e., one respective wheel 2 associated with each corresponding wheel motor 1, independently of the other wheels 2. Each wheel motor 1 includes a stator 3 implemented on a suspension structure 4 of the respective wheel 2 and a rotor 5 implemented on a semi-axle 6 connected to the respective wheel 2 to rotate together with the respective wheel 2 relative to the stator 3. The main vehicle engine 13 may be connected to the wheels 2 in the usual vein, i.e., a conventional manner, via a gear box 15. Front and back differentials may couple front and back semi-axles 6 with each other and with the vehicle engine 13. The electric wheel motors 1, or more specifically, the rotors 5 of each such motor 1, are integrated with the semi-axles 6 in a space- and weight-saving manner, which does not require any complicated assembly of additional components.

FIG. 2 shows a detailed view of the motor arrangement on one of the semi-axles 6. In this embodiment, the wheel motor 1 is configured as a radial flux permanent magnet motor having several rotor magnets 8 mounted on the respective semi-axle 6. In the shown embodiment, six rotor magnets 8 are configured as circumferential shell elements arranged around an axial direction 9 of the respective semi-axle 6 (see FIG. 2). These magnet shells may be assembled and bounded directly on a surface of the semi-axle 6. It should be understood however, that suitable magnets may also be embedded in the semi-axle 6, e.g. as internal magnets (in contrast to magnets placed on or above the surface).

Each wheel motor 1 is powered by one or several supercapacitors 7 installed in the motor vehicle 100 that are able to provide quick power to the wheel motors 1 on-demand. The supercapacitors 7 are configured to be recharged by regenerative braking of the motor vehicle 100. This combination of electric wheel motors 1 and supercapacitors 7 makes the solution ideally suited for dynamic driving applications like race, track, or rally driving. In such driving application, the wheel motors 1 provide ideal traction during acceleration phases with fully powered supercapacitors 7, which may afterwards be recharged during braking phases very quickly via regenerative braking.

In order to provide a corresponding dynamic torque management that orchestrates the wheel motors 1 together with the vehicle engine 13, a motor control 11 is provided. The motor control 11 activates and controls the wheel motors 1 selectively to provide dynamic torque management of the wheels 2 on demand during a driving situation. Torque may be provided by the wheel motors 1 either in addition to the main propulsion delivered by the vehicle engine 13 or, under certain circumstances, also alternatively to it, as is explained below with reference to FIG. 4, which shows a corresponding control method M.

FIG. 4 depicts three different modes that can be set by the motor control 11. On the one hand, the motor control 11 is configured to provide the dynamic torque management in order to generate active torque vectoring 23 of the wheels 2 depending on a driver steering angle request, a current yaw angle, and/or a current vehicle speed. Dynamic torque management may be used to correct a path of the vehicle 100 under dynamic and/or demanding driving conditions. For example, active torque vectoring 23 may be triggered in a case that the driver steering angle request, the current yaw angle, and the current vehicle speed all surpass predefined threshold values.

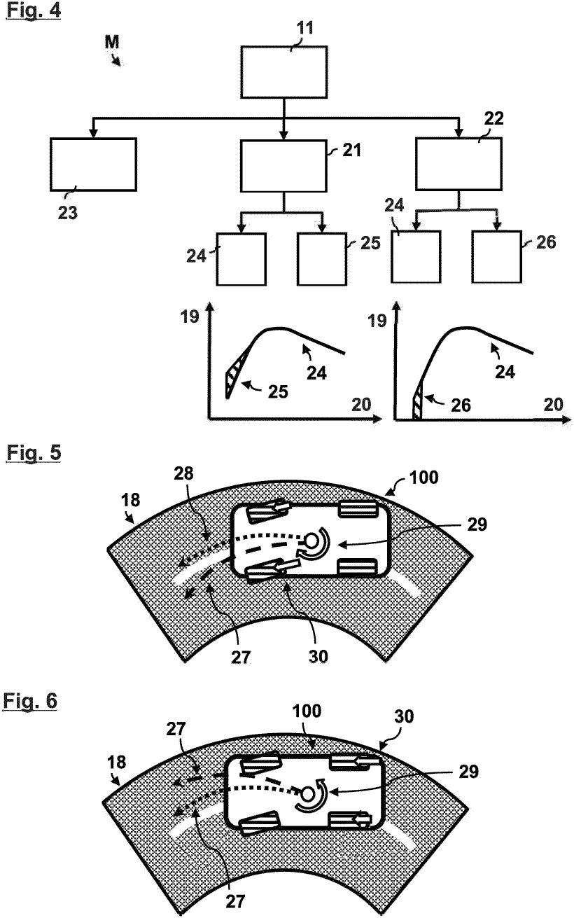

Examples for such driving situations are shown in FIGS. 5 and 6. FIG. 5 depicts a case for active electric torque vectoring 23. In this case, a corrective torque 30 is applied only on the front wheels 2 of the vehicle 100 in order to achieve a corrective yaw moment 29 that keeps the vehicle 100 from breaking out to the inside of the curve. FIG. 6 on the other hand shows the opposite case where only the rear wheels 2 are controlled with an additional torque 30 in order to keep the vehicle 100 from skidding outwards from the optimal track. Hence, the additional wheel motors 2 may be employed for dynamic traction control in order to compensate understeering or oversteering of a vehicle 100. To this end, the motor control 11 may run a dedicated control strategy to coordinate the engine 13 operations together with the wheel motors 2 and to simultaneously optimize usage of the supercapacitors 7 that are characterized by high density power but low energy capability.

In addition, the motor control 11 may provide dedicated driving modes that may be triggered automatically and/or may be set by an operator on request. Two such examples are shown in FIG. 4, a sport mode 21 and a low speed/creep mode 22.

In the case of the sport mode 21, the motor control 11 provides additional electric torque to the wheels 2 via the wheel motors 1 during acceleration phases depending on a driver acceleration request. The additional electric torque may be provided only if/when the driver acceleration request surpasses an acceleration threshold and if/when a state of charge of a respective supercapacitor 7 powering the wheel motors 1 surpasses a charge threshold. Hence, the vehicle 100 runs during sport mode 21 either with engine-only drive 24 or, if the abovementioned thresholds are passed (accelerator pedal pressed down and at least one supercapacitor sufficiently charged), with hybrid drive mode 25 where both the engine 13 and one or several of the wheel motors 1 are active in order to increase torque 19 (see the curve on the lower left of FIG. 4).

In the case of the low speed/creep mode 22, the motor control 11 may drive the wheels 2 solely on the basis of the wheel motors 1, e.g. in a case that a current vehicle speed is below a speed threshold and if/when a state of charge of a respective supercapacitor 7 powering the wheel motors 1 surpasses a charge threshold. Hence during creep mode 22, the vehicle 100 may either be operated in an engine only mode 24 or an electric only drive mode 26. The low speed mode 22 may be set for electric starting and/or creeping, e.g. during parking maneuvers, or other low load and/or low speed operations, as long as the supercapacitors are charged sufficiently (see the graph on the lower right of FIG. 4).

Summarizing the above, the present E-4WD system 10 thus is able to provide additional power to the wheels 2 on demand for short times, in particular during frequent acceleration and regenerative braking phases, and/or for torque vectoring. The present solution is thus different from conventional battery hybrid solutions where an electrical assistance acts continuously and during the overall driving operation of the vehicle. As a result, performance is improved over traditional 4WD solutions, such as for track driving and other highly dynamic applications. With the present solution, the size of the electric motors can be kept small in terms of power supply, which also implies a reduction in weight. The system 10 may not only be used for dynamic driving situations but also for driving assistance features, e.g. parking, creeping, and the like.

In the foregoing detailed description, various features are grouped together in one or more examples with the purpose of streamlining the disclosure. Further, the above description is intended to be illustrative, and not restrictive. It is intended to cover all alternatives, modifications, and equivalents of the different features and embodiments. Many other examples should become apparent to one of ordinary skill in the art upon reviewing the above specification. The embodiments were chosen and described in order to explain the principles of the disclosure and its practical applications to thereby enable others having ordinary skill in the art to utilize the disclosure and the various embodiments with various modifications as suited to the particular use contemplated.

| | |
|---|---|
| | Reference List |
| 1 | wheel motor |
| 2 | wheel |
| 3 | stator |
| 4 | suspension structure |
| 5 | rotor |
| 6 | semi-axle |
| 7 | supercapacitor |
| 8 | rotor magnet |
| 9 | axial direction |
| 10 | electric four-wheel drive (E-4WD) system |
| 11 | motor control |
| 12 | shock absorber |
| 13 | vehicle engine |
| 14 | inverter |
| 15 | differential |
| 16 | gear box |
| 17 | electric line |
| 18 | road |
| 19 | engine torque |
| 20 | engine speed |
| 21 | sport mode |
| 22 | low speed/creep mode |
| 23 | active torque vectoring |
| 24 | engine drive |
| 25 | hybrid drive |
| 26 | electric drive |
| 27 | current path |
| 28 | controlled path |
| 29 | yaw moment |
| 30 | torque correction |
| 100 | motor vehicle |
| M | method |

What is claimed is:

1. An electric four-wheel drive (E-4WD) system for a motor vehicle, the E-4WD system comprising:
wheel motors, each wheel motor of four of the wheel motors being configured as an electric motor to drive one respective wheel associated therewith,
wherein each wheel motor includes a stator implemented on a suspension structure of the respective wheel and a rotor implemented on a semi-axle connected to the respective wheel to rotate together with the respective wheel relative to the stator, and
wherein the wheel motors are configured to drive the respective wheels independently of each other.

2. The E-4WD system according to claim 1, wherein the wheel motors are powered by at least one supercapacitor.

3. The E-4WD system according to claim 2, wherein the at least one supercapacitor is configured to be recharged by regenerative braking.

4. The E-4WD system according to claim 1, wherein the wheel motors are configured as radial flux permanent magnet motors, and wherein one or several rotor magnets of each respective rotor are mounted on and/or are integrated in the respective semi-axle.

5. The E-4WD system according to claim 4, wherein the rotor magnets of each rotor are configured as circumferential shell elements arranged around an axial direction of the respective semi-axle.

6. The E-4WD system according to claim 1, further comprising a motor control configured to activate and control the wheel motors selectively to provide dynamic torque management of the respective wheels on demand during a driving situation.

7. The E-4WD system according to claim 6, wherein the dynamic torque management includes active torque vectoring.

8. The E-4WD system according to claim 6, wherein the motor control (11) is configured to provide the dynamic torque management depending on at least one of a driver steering angle request, a current yaw angle, or a current vehicle speed.

9. The E-4WD system according to claim 6, wherein the motor control is configured to provide additional electric torque to the respective wheels during acceleration phases depending on a driver acceleration request.

10. The E-4WD system according to claim 9, wherein the motor control is configured to provide the additional electric torque when the driver acceleration request surpasses an acceleration threshold and when a state of charge of the at least one supercapacitor powering the wheel motors surpasses a charge threshold.

11. The E-4WD system according to claim 6, wherein the motor control is configured to drive the respective wheels solely on basis of the wheel motors when a current vehicle speed is below a speed threshold and when a state of charge of the at least one supercapacitor powering the wheel motors surpasses a charge threshold.

12. A motor vehicle comprising the E-4WD system according to claim 1.

13. A method for controlling wheels of a motor vehicle having four of the wheels and four wheel motors, each wheel motor being configured as an electric motor for driving one respective wheel of the wheels, wherein each wheel motor includes a stator implemented on a suspension structure of the respective wheel and a rotor implemented on a semi-axle connected to the respective wheel to rotate together with the respective wheel relative to the stator, wherein the method includes the wheel motors driving the respective wheels independently of each other.

14. The method according to claim 13, comprising activating and controlling the wheel motors selectively with the motor control to provide dynamic torque management of the wheels on demand during a driving situation.

15. The method according to claim 14, wherein the dynamic torque management includes active torque vectoring.

16. The method according to claim 14, wherein the dynamic torque management is provided depending on at least one of a driver steering angle request, a current yaw angle, and a current vehicle speed.

17. The method according to claim 13, wherein additional electric torque is provided to the wheels during acceleration phases depending on a driver acceleration request.

18. The method according to claim 17, wherein the additional electric torque is provided when the driver acceleration request surpasses an acceleration threshold and when a state of charge of at least one supercapacitor powering the wheel motors surpasses a charge threshold.

19. The method according to claim 13, wherein the wheels are driven solely on basis of the wheel motors when a current vehicle speed is below a speed threshold and when a state of charge of at least one supercapacitor powering the wheel motors surpasses a charge threshold.
